(19) United States
(12) Patent Application Publication
(10) Pub. No.: US 2015/0079564 A1
(43) Pub. Date: Mar. 19, 2015

(54) METHOD AND SYSTEM OF ISSUING DIGITAL CONTENTS ACCORDING TO AN ACTIVITY PERFORMED BY A USER

(71) Applicant: NHN Entertainment Corporation, Seongnam-si (KR)

(72) Inventors: Hye-Ran LEE, Seongnam-si (KR); Jeong-Kwon Yang, Seongnam-si (KR); Chung-Hyun Yu, Seongnam-si (KR)

(21) Appl. No.: 14/487,866

(22) Filed: Sep. 16, 2014

(30) Foreign Application Priority Data
Sep. 17, 2013 (KR) 10-2013-0111476

(51) Int. Cl. G09B 19/00

(52) U.S. Cl. CPC G09B 19/0038
USPC 434/247

(57) ABSTRACT

A system and a method of issuing a digital content according to an activity performed by a user, using a display device and a service providing server, the method including providing a selecting interface on the display device, which includes user-selectable activities. The display device monitors performance of the activity to generate activity execution data, and transmits the activity execution data to the service providing server. The service providing server determines whether to issue a digital content based on the activity data, and transmits the result to the display device. Finally, the display device provides a content displaying interface that displays the issued digital content.

### CROSS REFERENCE TO RELATED APPLICATION

This application claims priority from and the benefit of Korean Patent Application No. 10-2013-0111476, filed on Sep. 17, 2013, which is hereby incorporated by reference for all purposes as if fully set forth herein.

### BACKGROUND

1. Field

Exemplary embodiments of the present invention relate to a system and a method of issuing a digital content according to an activity performed by a user. Particularly, exemplary embodiments of the present invention relate to a method and system for issuing a digital content as a reward for an activity performed by a user.

2. Discussion of the Background

Recently, urban centralization and progress of transportation have given rise to lack of exercise of each individual. Lack of exercise causes many social problems, such as obesity and other lifestyle related diseases. In order to help solve problems caused by lack of exercise, various clinics provide ways to remedy and prevent obesity, and, thus, an interest in health management programs has grown.

It is difficult to measure an individual's daily activities through the conventional health management programs or obesity clinics. Additionally, for many people, it is difficult to exercise at gym over a substantial period of time because, while individual's exercise can be measured easily, the gym provides a boring atmosphere of limited space and repetitive exercises.

However, recently, it has become possible to manage and recount an individual's exercise by using a smartphone application using various general functions of the smartphone. In other words, each individual can manage his or her own health more conveniently by downloading, installing, and operating applications on their smartphone that are related to various exercise activities.

Because of these recent advancements, there is a need to develop a program that allows a user to monitor his or her physical activities, allows a user to easily adjust the quantity of the activities he or she performs, and maintains a user's interest.

### SUMMARY

Exemplary embodiments of the present invention provide a method of issuing digital content capable of maintaining a user's consistent interest by adjusting an issuing rate of a digital content according to activity intensity and time duration of an activity performed by a user.

Exemplary embodiments of present invention also provide a digital content issuing system using the method described above.

Additional features of the invention will be set forth in the description which follows, and in part will be apparent from the description, or may be learned by practice of the invention.

An exemplary embodiment of the present invention discloses a method of issuing a digital content according to an activity performed by a user using a display device and a service providing server according to an exemplary embodiment of the present invention may include providing a selecting interface, displaying a plurality of selectable activities, and allowing the user to select at least one activity, using a device. The activities may include habitual physical activity, an exercise without using equipment, and an exercise using equipment. Next, the user's device monitors the user's execution of the selected activity to generate an activity execution data based on the user's execution and transmitting the activity execution data to the service providing server. Next, a server determines whether to issue a digital content based on the activity execution data and which digital content to be issued. Finally, the user's device provides a content displaying interface displaying the digital content determined by the service providing server.

An exemplary embodiment of the present invention also discloses a system for issuing a digital content according to an activity performed by a user including at least one display device and a service providing server. The display device generates an activity execution data. The service providing server compares the activity execution data to reward condition information to determine whether and which to issue a digital content to the user, and provides a digital content to the user when the activity execution data meet the reward condition information.

Thus, according to an exemplary embodiment of the present invention, a method and a system for issuing a digital content according to an activity performed by a user may maintain the user's interest and provide motivation to the user by adjusting an issuing rate of a digital content according to an exercise intensity and a time duration of an activity performed by a user is provided.

Also, according to an exemplary embodiment of the present invention, the user's device may provide different exercise activities and may possess various health management applications.

In addition, according to an exemplary embodiment of the present invention, a user may utilize a personalized health management program by measuring exercise intensity throughout an individual's daily life.

In addition, digital content obtained by the user as a reward for performing an activity may be used in various digital content stores.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram showing a system for issuing a digital content according to an exemplary embodiment of the present invention.

FIG. 2 is a flowchart showing a method of issuing the digital content using the system of FIG. 1.

FIG. 3 is a diagram showing a more detailed explanation of the method of issuing the digital content of FIG. 2.

FIG. 4 shows an example of reward condition information stored in a service providing server which is used to determine whether to issue a digital content.

### DETAILED DESCRIPTION OF THE ILLUSTRATED EMBODIMENTS

The present invention is described more fully hereinafter with reference to the accompanying drawings, in which example embodiments of the present invention are shown.

The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that, although the terms first, second, third etc. may be used herein to describe various elements, components, regions, layers and/or sections, these elements, components, and/or sections should not be limited by these terms. These terms are only used to distinguish one element, component, region, layer or section from another region, layer or section. Thus, a first element, component, or section discussed below could be termed a second element, component, or section without departing from the teachings of the present invention.

The terminology used herein is for the purpose of describing particular example embodiments only and is not intended to be limiting of the present invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

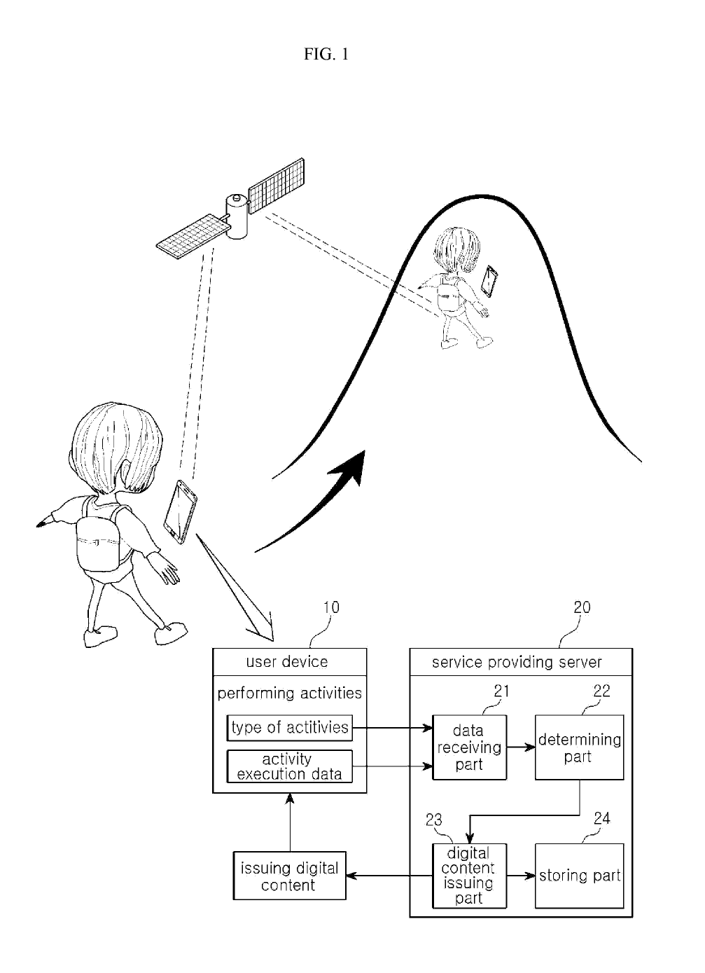

FIG. 1 is a diagram explaining a system for issuing a digital content according to an exemplary embodiment of the present invention.

Referring to FIG. 1, a system for issuing a digital content according to an exemplary embodiment of the present invention includes at least one display device 10 and a service providing server 20. The display device 10 generates activity execution data according to an activity performed by a user. The display device may include a smartphone or a tablet, but is not limited thereto. The service providing server 20 compares the activity execution data to reward condition information to determine whether to issue a particular type of digital content to the user, and provides the corresponding digital content to the user when the activity execution data meets the reward condition information.

The service providing server 20 may include a data receiving part 21, a determining part 22, a digital content issuing part 23, and a storing part (memory) 24. The data receiving part 21 receives the activity execution data from the display device 10. The determining part 22 selects an activity intensity using the activity execution data, selects reward condition information, and determines whether to issue a digital content data based on the activity intensity and the reward condition information. The digital content issuing part 23 issues the digital content to the display device 10 according to the result of the determining part 22. The storing part 24 stores records of the activity execution data transmitted from the display device 10 and the issued digital content. Hardware used for data receiving part 21 may be a data receiver. Hardware used for the determine part 22 and the digital content issuing part 23 may be one or more processors. Hardware used for the storing part 24 may be memory.

The determining part 22 may select the activity intensity from standardized exercise intensity information according to the activity type or an exercise intensity included in the activity execution data transmitted from the display device 10.

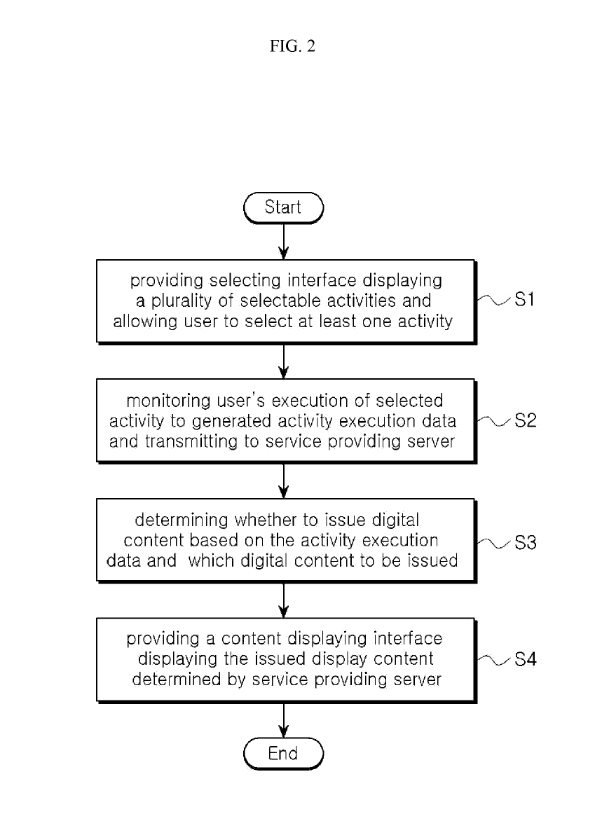

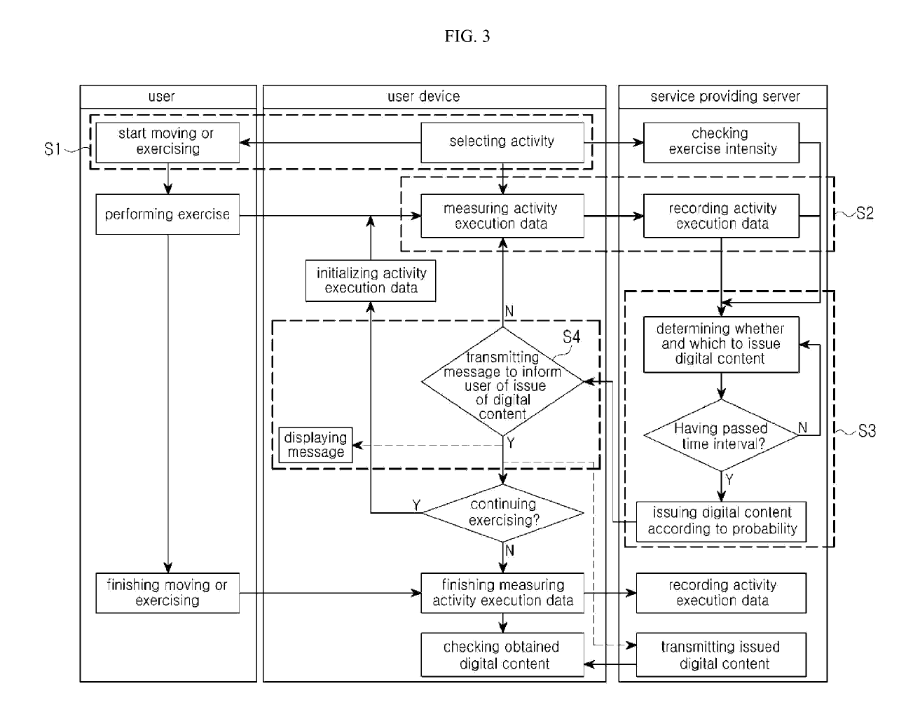

FIG. 2 is a flowchart showing a method of issuing the digital content of FIG. 1, and FIG. 3 is a diagram showing a more detailed explanation of the method of issuing the digital content of FIG. 2.

Referring to FIGS. 2 and 3, a method of issuing a digital content according to an exemplary embodiment of the present invention includes steps S1 to S4. In the step S1, a display device 10 provides a selecting interface through which activities are selectable. Using the selecting interface, a user is capable of selecting at least one activity among the plurality of the activities.

That is, in the step S1, the display device 10 accesses a service providing server 20, which issues digital content, and displays a menu including plurality of activities such that the user may select at least one activity.

Then, in the step S2, the display device 10 monitors the user's execution of the activity that is selected from the selecting interface, generates activity execution data based on the user's execution, and transmits the activity execution data to the service providing server 20.

Next, in the step S3, the service providing server 20 determines whether to issue digital content and what digital content to issue, based on the activity execution data transmitted by the display device 10, and transmits the result to the display device 10.

Herein, during the step for issuing the digital content, the digital content is randomly issued according to a set time interval between issuance of digital content and probability, according to the type of activity performed by the user or an exercise intensity of the user.

Finally, in the step S4, the display device 10 may provide a content displaying interface that displays the issued digital content determined by the service providing server 20, thereby allowing the user to view the issued digital content.

The activities selectable by the user may include habitual physical activities (i.e. stretching, stair climbing, etc.), exercise without using equipment (i e running, walking, hiking, etc.), and exercises with equipment (i.e. golf, skiing, riding, etc.), but is not limited thereto.

During the step of determining whether digital content should be issued and which digital content to issue to the user within step S3, the digital content may be issued after a time interval according to a probability. Additionally, the service providing server 20 may limit a maximum number of issuance of the digital content in a day.

The time interval and the probability may be varied according to the type of activity selected by a user or the intensity of the exercise.

For example, it is normal that a habitual activity, such as housework, burns fewer calories than an activity such as running or riding. Therefore, the former activity may have a smaller reward frequency than the latter activity. For example, in the case of a habitual activity, digital content may be determined whether to issue after every 60 min. of activity with 10% probability and after 2 hours of activity with 20% probability. In a case of running, however, a determination to issue digital content may occur after every 30 min. of activity with a 60% probability and after every 2 hours of activity with a 100% probability. Therefore, higher exercise intensity also provides a higher probability of reward.

To give a differentiated reward according to an activity intensity, the service providing server 20 may include a database to store standard exercise intensity information according to activity type. Additionally or alternatively, the service providing server 20 may calculate an actual exercise intensity of a user and store the result based on data measured by the display device 10, geographical information, and the standardized exercise intensity.

For example, the service providing server 20 may store standardized exercise intensity information for each activity, the corresponding time interval at which content should be issued and the probability of the content being issued.

The service providing server 20 may calculate an exercise intensity by using a moving velocity and a moving path of the user from position information transmitted from a GPS of the display device 10, a gradient and a distance of the moving path of the user by using external geographic information providing server (not shown) or geographic information stored in the service providing server 20. The service providing server 20 may calculate an exercise intensity by using the geographic information of the activity performed by the user and the moving velocity of the user. Additionally, the service providing server 20 may further evaluate an exercise intensity of the user by calculating calories consumption using pre-stored body information (i.e. weight) of the user, an exercise intensity calculated by the service providing server 20, and a duration time of the activity.

In other words, the service providing server 20 detects a position by receiving a GPS signal from the display device 10 and calculates a moving distance and a moving time. A moving velocity may be calculated by dividing the moving distance by the moving time. The calories consumption may be calculated when the moving distance, the moving time, and the moving velocity is calculated. Calorie consumption may additionally be augmented using pre-stored body information (i.e. weight) of a user.

The above description explains the case that the service providing server 20 calculates an exercise intensity using position information transmitted by the display device 10 and geographical information. Alternatively, the display device 10 may calculate the exercise intensity by using position information of the display device 10 and geographical information transmitted by the service providing server 20, and transmit the calculated result to the service providing server 20.

The service providing server 20 may transmit a message to inform the display device 10 of issuance of the digital content.

Also, when digital content is issued as a reward, the display device 10 or the service providing server 20 may initialize the activity execution data to start measuring the activity execution data from the beginning, and after a time interval, determine once more whether to issue digital content according to the time interval and the probability.

When a digital content is not issued after the time interval, as determined by the probability, the display device 10 or the service providing server 20 continues to measure the activity execution data, and may increase the probability.

For example, when the user selects running as an activity, digital content may be issued after 60 min. with 10% of probability. However, if the digital content is not issued after 60 min., the activity execution data may be re-initialized and measured continuously. After another 60 min., the probability may be increased to 20%, and the digital content may thereby be determined to be issued with the increased probability.

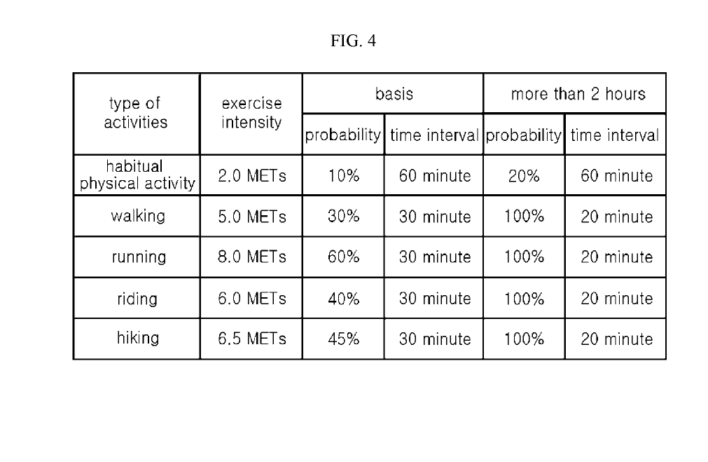

FIG. 4 shows an example of reward condition information stored in a service providing server which is used to determine whether to issue a digital content.

Referring to FIG. 4, a database storing reward condition information, which is stored in a service providing server 20, according to an embodiment of the present invention, stores types of activities, time intervals corresponding to each of the types of activities, and probabilities according to each of the types of activities. However, the data shown in FIG. 4 is exemplary, and may be changed according to need.

Additionally, several steps of the exemplary embodiments of the present invention, also, are implemented using code program, which can be read by a computer, on a computer readable recording medium.

The computer-readable recording medium may include, but is not limited to ROM, RAM, CD-ROM, magnetic tapes, floppy disks, optical data storage devices, and so on, and carrier waves (eg, transmission through the Internet) . The computer readable recording medium in a computer system connected to the network in a distributed manner by the computer readable code is stored and executed.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A method of issuing a digital content according to an activity performed by a user, comprising:
(a) providing a user interface on a display device, the user interface comprising selectable activities;
(b) monitoring the execution of a selected activity by a user, to generate activity execution data, and transmitting the activity execution data to a service providing server, the monitoring, generating, and transmitting being performed by the display device;
(c) determining, by the service providing server, whether to issue digital content based on the activity execution data, and providing a content displaying interface on the display device, the content displaying interface comprising the issued digital content.

2. The method of claim 1, wherein operation (c) is performed repeatedly according to a time interval and a probability.

3. The method of claim 2, wherein at least one of the time interval and the probability are determined based on a type of the activity.

4. The method of claim 3, wherein the service proving server comprises a database comprising exercise intensity information and corresponding time interval information and probability information, according to the type of the activity.

5. The method of claim 2, wherein at least one of the time interval and the probability are determined based on an exercise intensity of the selected activity.

6. The method of claim 5, wherein the exercise intensity is calculated based on at least one of geographical position information transmitted by the display device and an exercise duration measured by the display device.

7. The method of claim 5, wherein the exercise intensity is calculated based on exercise intensity information and the exercise duration measured by the display device.

8. The method of claim 6, wherein the exercise intensity is calculated from a velocity and a path, corresponding to the position information transmitted by the display device, a topography of the path based on the geographic information, and an exercise duration calculated from the activity execution data.

9. The method of claim 2, further comprising, (e) transmitting from the service providing server to the display device a message comprising a notification of the issuance of the digital content.

10. The method of claim 2, wherein the service providing server increases the probability when operation (c), is repeated if the digital content is not issued after operation (c).

11. The method of claim 10, wherein the time period after which operation (c) repeats is a multiple of the time interval.

12. The method of claim 11, further comprising, (f) resetting, by the service providing server, the time interval when the digital content has been issued.

13. The method of claim 1, wherein the service providing server sets a maximum number times the digital content can be issued in a day.

14. The system of claim 1, wherein the activity comprises at least one of a habitual physical exercise, an exercise without using equipment, and an exercise using equipment.

15. A digital content issuing system, comprising:
at least one display device configured to generate an activity execution data; and
a service providing server configured to store a reward condition information to determine whether to issue digital content, and configured to issue and transmit the digital content to the display device when the activity execution data transmitted by the display device to the service providing server satisfies the reward condition information.

16. The system of claim 15, wherein the service providing server comprises:
a data receiver configured to receive the activity execution data from the display device;
a processor configured to determine activity intensity using the activity execution data, select reward condition information, and determine whether to issue a digital content based on the activity intensity and the reward information;
a digital content issuing part configured to issue the digital content to the display device according to the determination of the processor; and
a memory configured to store a record of the activity execution data and the issued digital content, after the digital content is issued.

17. The system of claim 16, wherein the exercise intensity is determined using exercise intensity information based on a type of the activity or an exercise intensity comprising the activity execution data.

18. The system of clam 17, wherein the exercise intensity is calculated from at least one of a velocity and a path of a user, a topography of the moving path based on the geographic information, and a duration of the activity.

19. The system of claim 18, wherein the velocity and the path are calculated from position information received from a GPS of the display device.

20. The system of claim 18, wherein the service providing server is configured to calculate the exercise intensity using the velocity and the path, and to calculate the user's calorie consumption based on the exercise intensity and physical information about the user.
